(19) United States
(12) Patent Application Publication
(10) Pub. No.: US 2005/0044762 A1
(43) Pub. Date: Mar. 3, 2005

(54) Illustrative drug card

(76) Inventor: Neelima Atluri, Tarzana, CA (US)

Correspondence Address: TOPE-MCKAY & ASSOCIATES, 23852 PACIFIC COAST HIGHWAY #311, MALIBU, CA, 90265, US

(21) Appl. No.: 10/648,069

(22) Filed: Aug. 26, 2003

(51) Int. Cl. G09F 7/04

(52) U.S. Cl. 40/600

(57) ABSTRACT

The present invention relates to an illustrative drug card to help patients understand when and how to administer medications. The illustrative drug card uses illustrations and symbols allowing patients to easily differentiate between medications, recognize which pills to administer at different times of a day, and recognize which medications to administer with food. Additionally, the illustrative drug card may take the form of a refrigerator magnet, or a foldable, wallet-sized booklet. Furthermore, the illustrative drug card may be printed in several languages, including brail, allowing blind patients to read the brail.

### FIELD OF INVENTION

The present invention relates to drug cards that help patients understand when and how to administer medications, and more specifically, to an illustrative drug card using illustrations and symbols that allow patients to easily differentiate between medications, recognize which pills to administer at different times of a day, and recognize which medications to administer with food.

### BACKGROUND OF INVENTION

A purpose of an illustrative drug card is to alleviate a problem of Adverse Drug Effects (ADEs) that cost our nation billions of dollars in healthcare expenses. There are currently computerized applications being developed that allow physicians to electronically prescribe medications to help eliminate transcribing errors. However, these applications do little to reduce a large contributing factor of ADEs, patient non-compliance. Patient non-compliance occurs when patients take their medication at a wrong time, take extra doses, take extra medication for a given dose, omit doses, use outdated medication, or take a wrong medication. It is estimated that 50% of all prescriptions filled are taken incorrectly. Patient non-compliance causes 125,000 deaths per year and leads to 10 to 25% of hospital and nursing home admissions.

Compounding this problem is polypharmacy. Polypharmacy, use of five or more drugs at one time by one patient, is very common in an elderly population. Approximately one half (46%) of elderly patients admitted to U.S. hospitals are taking seven or more medications. Polypharmacy leads to not only confusion in patients, but also in prescribing physicians, as it is often difficult to remember a full scope of the patient's medications. Additionally, when a patient goes to a new doctor, the patient often forgets to tell the new doctor what previous doctors have prescribed, leading to a major cause of ADEs.

Attempting to alleviate these problems are products reminding patients when it is time to take their medication and automatically dispensing daily dosages of their medication. However, the patient or their caregiver often improperly fills these auto-dispensers, in part, because they misidentify the drugs to begin with. In an attempt to prevent drug misidentification, an information card and label have been invented containing photographs of the patient's medications.

A drug labeling and prescription system is disclosed in U.S. Pat. No. 4,918,604 to Baum, where each prescription label contains a graphic illustration of a prescription drug. While this may help patients to recognize which prescriptions belong in which container, it does little to help patients after the prescriptions have been put in a generic dispensing container. Additionally, the graphic illustration is a single illustration and not a list, compounding polypharmacy problems.

In order to reduce polypharmacy problems, an invention was made incorporating a medicine dispenser with a graphic list of medications administered by a patient. This is disclosed in U.S. Pat. No. 6,550,618 B2 to Peterson, where an information card is attached to a medicine tray. The information card in this patent contains a photograph of several medications administered by a patient. While the invention disclosed in the Peterson patent contains a graphical illustration of the medications, it does not contain graphical illustrations of when or how to administer the medications. Additionally, because the information card in the Peterson patent is attached directly to the medicine tray, it does not take the form of a convenient, easily accessible and portable card.

Therefore, there exists a need to present a convenient, illustrative list of medications and allergies to patients, caregivers, physicians, pharmacies, and HMOs, ultimately reducing the confusion patients experience when taking their prescriptions.

The illustrative drug card solves these problems by combining patient instructions for medication administration with illustrations and symbols. Through use of the illustrative drug card, patients may easily differentiate between medications and recognize which pills to take at different times of a day, and which pills to take with meals. Additionally, because the illustrative drug card may be produced as a refrigerator magnet or foldable wallet-sized booklet, it is convenient, easily accessible, and portable.

### SUMMARY OF INVENTION

The drug card in the present invention comprises an illustrative drug card with illustrations and symbols. The illustrative drug card has an illustrative portion containing a list of medications used by a patient, where the list is represented by an illustration of each medication; a visually-aided instruction regarding when to administer a medication listed in the list of medications; and a visually-aided instruction on how to administer a medication listed in the list of medications.

In another aspect, the illustrative drug card is foldable into a wallet-sized booklet.

In yet another aspect, the illustrative drug card is a magnet. The magnet may be a refrigerator magnet or any other suitable magnet.

In another aspect, the illustration of each medication is a photograph.

In another aspect, the illustration of each medication is a pouch, where an actual medication may be placed.

In yet another aspect, the visually-aided instruction regarding when to administer a medication includes a symbol representing a time of a day. The symbol representing a time of a day includes an item selected from a group consisting of a sun, moon, and stars.

In another aspect, the visually-aided instruction regarding how to administer a medication is a set of symbols representing what to administer with the medication. The symbols representing what to administer with the medication include an item selected from a group consisting of a liquid and food.

In yet another aspect, on the illustrative portion, the illustrative drug card further comprises patient-specific allergy information, contact information, and medication interaction precautions.

Finally, the illustrative portion further comprises brail, whereby blind patients may read the illustrative drug card through the brail.

### BRIEF DESCRIPTION OF THE DRAWINGS

The nature of the drug card described herein will be readily apparent in the following drawings, in which:

FIG. 1 is a front perspective view of the present invention, showing the illustrative aspects of the drug card, with the illustration of each medication as a photograph;

FIG. 2A is a cross-sectional view of the present invention, taken from line II-II of FIG. 1, showing the illustration as separately formed and affixed to a magnetic backing;

FIG. 2B is a cross-sectional view of the present invention, taken from line II-II of FIG. 1, showing the illustration as being printed directly upon a magnet or magnetic paper;

FIG. 3 is a front perspective view of the present invention, showing the illustrative aspects of the drug card, with the illustration of each medication as a pouch where an actual medication may be placed;

FIG. 4A is a cross-sectional view of the present invention, taken from line IV-IV of FIG. 3, showing the illustrative aspects as separately formed and affixed to a magnetic backing, with the pouch affixed to the illustration;

FIG. 4B is a cross-sectional view of the present invention, taken from line IV-IV of FIG. 3, showing the illustrative aspects as being printed directly upon a magnet or magnetic paper, with the pouch affixed to the magnet or magnetic paper;

FIG. 5A is a front perspective view of the present invention, where the illustrative drug card has been folded into a wallet-sized booklet;

FIG. 5B is a cross-sectional view of the present invention, taken from line VI-VI of FIG. 5A, where the illustrative drug card has been folded into the wallet-sized booklet;

FIG. 5C is side perspective view of the present invention, showing the illustrative drug card being folded into the wallet-sized booklet; and

FIG. 6 is a front perspective view of the present invention, where the illustrative drug card is printed in brail.

### DETAILED DESCRIPTION

The present invention relates to a drug card to help patients understand when and how to administer medications. More particularly, it relates to an illustrative drug card using illustrations and symbols. Through use of the illustrations and symbols, patients will easily differentiate between medications, recognize which pills to administer at different times of a day, and recognize which medications to administer with food. Additionally, the illustrative drug card may take the form of a refrigerator magnet, or a foldable, wallet-sized booklet.

The following description, taken in conjunction with the referenced drawings, is presented to enable one of ordinary skill in the art to make and use the invention. Various modifications will be readily apparent to those skilled in the art, and the general principles defined herein may be applied to a wide range of aspects. Thus, the present invention is not intended to be limited to the aspects presented, but is to be accorded the widest scope consistent with the principles and novel features disclosed herein. Furthermore it should be noted that unless explicitly stated otherwise, the figures included herein are illustrated diagrammatically and without any specific scale, as they are provided as qualitative illustrations of the concept of the present invention.

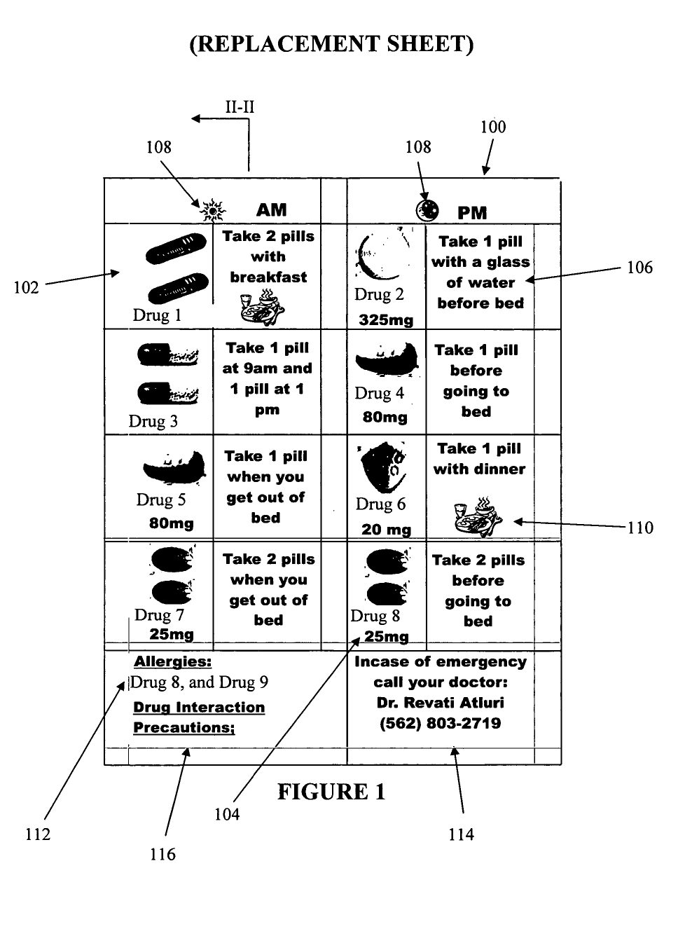

Referring to the figures, FIG. 1 illustrates an aspect of the drug card 100 in accordance with the present invention. The drug card 100 may be fabricated in any suitable form for ease of accessibility, non-limiting examples of which include a refrigerator magnet or a foldable, wallet-sized booklet. The drug card 100 contains a list of medications used by a patient, where the list is represented by an illustration of each medication 102. The patient may be any entity taking medication, such as a human or a pet. The list also contains pertinent name and dosage information 104 relevant to each medication. The illustration of each medication 102 may be in the form of a photograph, an openable (able to be opened) pouch where an actual medication may be placed, or any other suitable means for reproducing an image.

The drug card 100 also contains a visually-aided instruction on when to administer a medication. The visually-aided instruction on when to administer a medication may be in the form of text 106 or symbols representing different times of a day 108, non-limiting examples of which include a sun, moon and stars. The drug card 100 further contains a visually-aided instruction on how to administer a medication. The visually-aided instruction may be in the form of text 106 or symbols representing what to administer with the medication 110, non-limiting examples of which include liquids or food.

The drug card 100 contains additional patient-specific information, non-limiting examples of which include, allergy information 112, contact information 114, and medication interaction precautions 116.

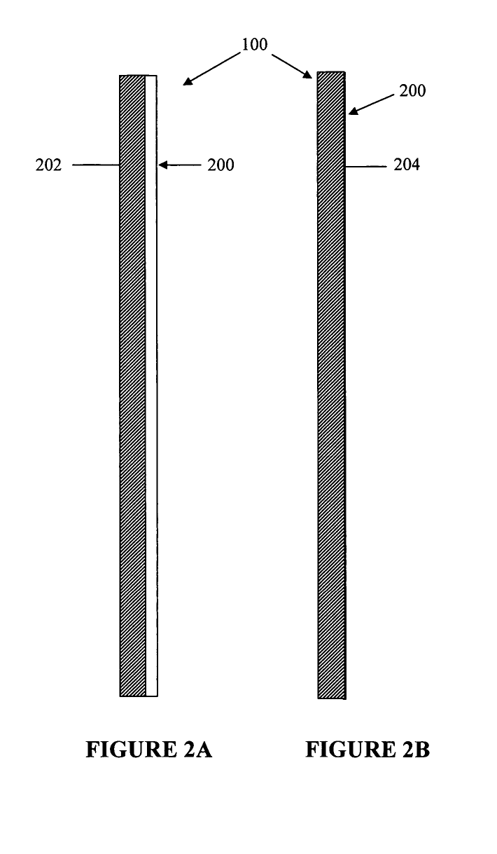

As illustrated in FIGS. 2A and 2B, the drug card 100 may be a refrigerator magnet. As shown in FIG. 2A, an illustrative portion 200 of the drug card 100 may be separately formed and affixed to a magnetic backing 202. The magnetic backing 202 may be any suitable medium for creating a magnetic field, non-limiting examples of which include a standard magnet or magnetic paper. The illustrative portion 200 may be affixed to the magnetic backing 202 through any suitable means for affixing two mediums together, non-limiting examples of which include glue, tape, staples, and in-sewn. As shown in FIG. 2B, the illustrative portion 200 of the drug card 100 may be printed directly upon a magnet 204. The magnet 204 may be any suitable medium for creating a magnetic field, non-limiting examples of which include a standard magnet or magnetic paper.

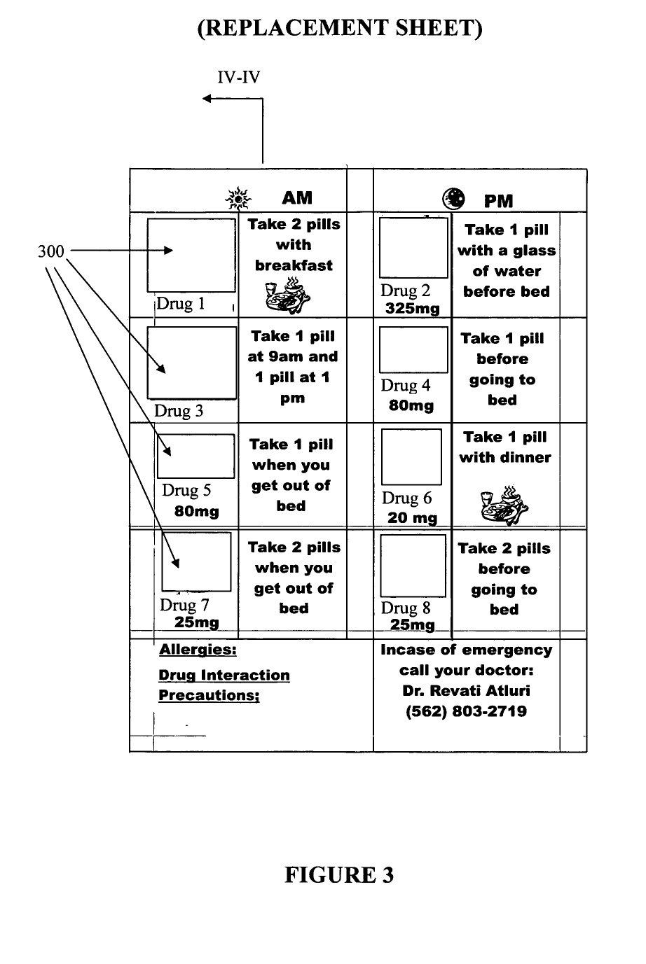

Another aspect is shown in FIG. 3, where the illustration of each medication takes the form of a pouch 300. The pouch 300 is an openable pouch 300 where an actual medication may be placed, allowing the patient to see the actual appearance of the appropriate medication to administer.

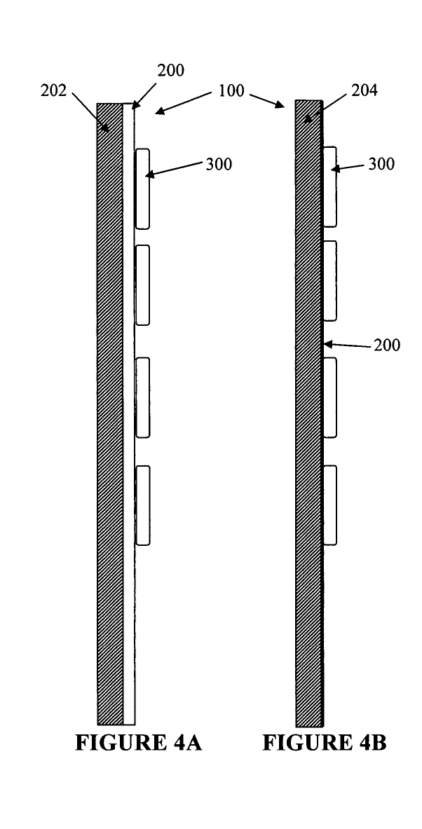

As illustrated in FIGS. 4A and 4B, the pouch 300 is affixed with the illustrative portion 200 of the drug card 100. As shown in FIG. 4A, the illustrative portion 200 of the drug card 100 may be separately formed and affixed to a magnetic backing 202. The magnetic backing 202 may be any suitable medium for creating a magnetic field, non-limiting examples of which include a standard magnet or magnetic paper. The illustrative portion 200 may be affixed to the magnetic backing 202 through any suitable means for affixing two mediums together, non-limiting examples of which include glue, tape, staples, and in-sewn. The pouch 300 is affixed to the illustrative portion 200 of the drug card 100 through any suitable means for affixing two mediums together, non-limiting examples of which include glue, tape, staples, and in-sewn. As shown in FIG. 4B, the illustrative portion 200 of the drug card 100 may be printed directly upon a magnet 204. The magnet 204 may be any suitable medium for creating a magnetic field, non-limiting examples of which include a standard magnet or magnetic paper. The pouch 300 is affixed to the illustrative portion 200 of the drug card 100 through any suitable means for affixing two mediums together, non-limiting examples of which include glue, tape, staples, and in-sewn.

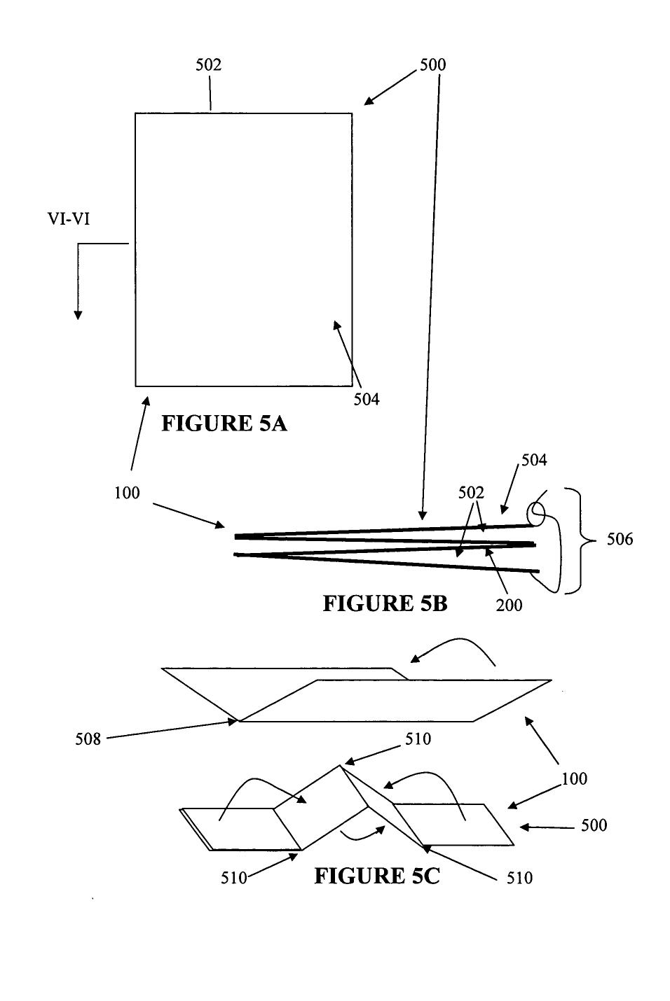

Illustrated in FIGS. 5A, 5B and 5C, is another aspect of the drug card 100. In this aspect, the drug card 100 takes the form of a foldable, wallet-sized booklet 500. FIG. 5A shows a front perspective of the drug card 100, after it has been folded into the wallet-sized booklet 500. Once folded, the wallet-sized booklet 500 has an internal portion 502 and an external portion 504. As shown in FIG. 5B, once folded into the wallet-sized booklet 500, the illustrative portion 200 is in the internal portion 502. Additionally, once folded, the wallet-sized booklet 500 may have a means for holding any folds together 506. The means for holding any folds together 506 may be any suitable means for affixing two mediums together, non-limiting examples of which include draw ties, Velcro, hook and loop, and push-snaps.

As shown in FIG. 5C, the drug card 100 may be folded into the wallet-sized booklet 500 through any suitable folding configuration. For example, the drug card 100 may be folded in half lengthwise 508 and then folded again along several smaller folds 510.

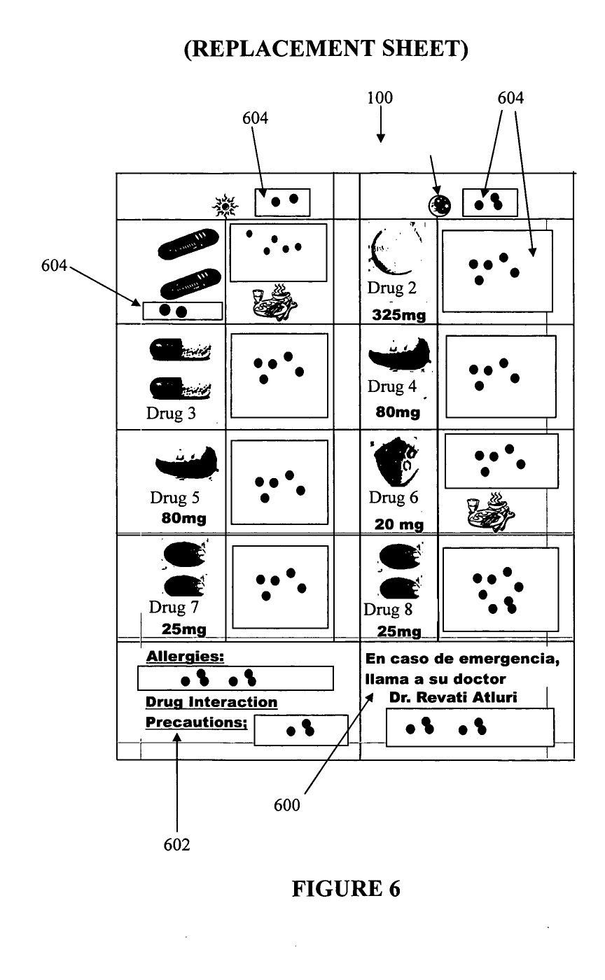

As illustrated in FIG. 6, the drug card 100 may be printed in several different languages. For example, the drug card 100 may be printed in Spanish 600, English 602, or brail 604, whereby blind patients may read the illustrative drug card using the brail 604.

1. An illustrative drug card, comprising:
an illustrative portion, where the illustrative portion includes a list of medications used by a patient, with the list represented by an illustration of each medication;
a visually-aided instruction on when to administer a medication listed in the list of medications; and
a visually-aided instruction on how to administer a medication listed in the list of medications.

2. An illustrative drug card as set forth in claim 1, wherein the illustrative drug card is foldable into a wallet sized booklet.

3. An illustrative drug card as set forth in claim 1, wherein the illustrative drug card is a magnet.

4. An illustrative drug card as set forth in claim 1, wherein the illustration of each medication is a photograph.

5. An illustrative drug card as set forth in claim 1, wherein the illustration of each medication is a pouch, where an actual medication may be placed.

6. An illustrative drug card as set forth in claim 1, wherein the visually-aided instruction on when to administer a medication includes a symbol representing a time of a day.

7. An illustrative drug card as set forth in claim 6, wherein the symbol representing a time of a day includes an item selected from a group consisting of a sun, moon, and stars.

8. An illustrative drug card as set forth in claim 1, wherein the visually-aided instruction on how to administer a medication is a symbol representing what to administer with the medication.

9. An illustrative drug card as set forth in claim 8, wherein the symbol representing what to administer with the medication includes an item selected from a group consisting of a liquid and food.

10. An illustrative drug card as set forth in claim 1, further comprising patient-specific allergy information on the illustrative portion.

11. An illustrative drug card as set forth in claim 1, further comprising contact information on the illustrative portion.

12. An illustrative drug card as set forth in claim 1, further comprising medication interaction precautions on the illustrative portion.

13. An illustrative drug card as set forth in claim 1, further comprising brail on the illustrative portion, whereby blind patients may read the illustrative drug card through the brail.

14. An illustrative drug card as set forth in claim 2, wherein the illustration of each medication is a photograph.

15. An illustrative drug card as set forth in claim 14, wherein the visually-aided instruction on when to administer a medication includes a symbol representing a time of a day.

16. An illustrative drug card as set forth in claim 15, wherein the symbol representing a time of a day includes an item selected from a group consisting of a sun, moon, and stars.

17. An illustrative drug card as set forth in claim 16, wherein the visually-aided instruction on how to administer a medication is a symbol representing what to administer with the medication.

18. An illustrative drug card as set forth in claim 17, wherein the symbol representing what to administer with the medication includes an item selected from a group consisting of a liquid and food.

19. An illustrative drug card as set forth in claim 18, further comprising patient-specific allergy information on the illustrative portion.

20. An illustrative drug card as set forth in claim 19, further comprising contact information on the illustrative portion.

21. An illustrative drug card as set forth in claim 20, further comprising medication interaction precautions on the illustrative portion.

22. An illustrative drug card as set forth in claim 21, further comprising brail on the illustrative portion, whereby blind patients may read the illustrative drug card through the brail.

23. An illustrative drug card as set forth in claim 3, wherein the illustration of each medication is a photograph.

24. An illustrative drug card as set forth in claim 23, wherein the visually-aided instruction on when to administer a medication includes a symbol representing a time of a day.

25. An illustrative drug card as set forth in claim 24, wherein the symbol representing a time of a day includes an item selected from a group consisting of a sun, moon, and stars.

26. An illustrative drug card as set forth in claim 25, wherein the visually-aided instruction on how to administer a medication is a symbol representing what to administer with the medication.

27. An illustrative drug card as set forth in claim 26, wherein the symbol representing what to administer with the medication includes an item selected from a group consisting of a liquid and food.

28. An illustrative drug card as set forth in claim 27, further comprising patient-specific allergy information on the illustrative portion.

29. An illustrative drug card as set forth in claim 28, further comprising contact information on the illustrative portion.

30. An illustrative drug card as set forth in claim 29, further comprising medication interaction precautions on the illustrative portion.

31. An illustrative drug card as set forth in claim 30, further comprising brail on the illustrative portion, whereby blind patients may read the illustrative drug card through the brail.

32. An illustrative drug card as set forth in claim 3, wherein the illustration of each medication is a pouch, where an actual medication may be placed.

33. An illustrative drug card as set forth in claim 32, wherein the visually-aided instruction on when to administer a medication includes a symbol representing a time of a day.

34. An illustrative drug card as set forth in claim 33, wherein the symbol representing a time of a day includes an item selected from a group consisting of a sun, moon, and stars.

35. An illustrative drug card as set forth in claim 34, wherein the visually-aided instruction on how to administer a medication is a symbol representing what to administer with the medication.

36. An illustrative drug card as set forth in claim 35, wherein the symbol representing what to administer with the medication includes an item selected from a group consisting of a liquid and food.

37. An illustrative drug card as set forth in claim 36, further comprising patient-specific allergy information on the illustrative portion.

38. An illustrative drug card as set forth in claim 37, further comprising contact information on the illustrative portion.

39. An illustrative drug card as set forth in claim 38, further comprising medication interaction precautions on the illustrative portion.

40. An illustrative drug card as set forth in claim 39, further comprising brail on the illustrative portion, whereby blind patients may read the illustrative drug card through the brail.
